(19) United States
(12) Patent Application Publication
(10) Pub. No.: US 2009/0261247 A1
(43) Pub. Date: Oct. 22, 2009

(54) Linear Ion Trap with Four Planar Electrodes

(76) Inventors: Robert Graham Cooks, West Lafayette, IN (US); Zheng Ouyang, West Lafayette, IN (US); Yishu Song, Ponca City, OK (US); Guangxiang Wu, Waltham, MA (US)

Correspondence Address: BRINKS HOFER GILSON & LIONE, P.O. BOX 10395, CHICAGO, IL, 60610, US

(21) Appl. No.: 11/814,334

(22) PCT Filed: Feb. 7, 2006
(86) PCT No.: PCT/US06/04081

§ 371 Date: May 2, 2008

Related U.S. Application Data
(60) Provisional application No. 60/650,729, filed on Feb. 7, 2005.

(51) Int. Cl. B01D 59/44

(52) U.S. Cl. 250/292; 250/290

(57) ABSTRACT

A rectilinear ion trap includes a first pair of spaced planar RF electrodes, mounted in parallel and a second pair of spaced planar electrodes, mounted in parallel and orthogonal to the first pair of electrodes. The configuration of the pairs of electrodes define an axial direction and a radial direction. The trap further includes an RF source that applies an RF voltage to at least one of the pairs of RF electrodes to generate RF fields to trap ions in the axial and radial directions.

### RELATED APPLICATION

This application claims the benefit of U.S. Provisional Application No. 60/650,729, filed Feb. 7, 2005, the entire contents of which are incorporated herein by reference.

### GOVERNMENT INTERESTS

This invention was made with Government support under Grant No. N00014-02-1-0834 awarded by the Office of Naval Research and Grant No. W912HZ-04-2-0001 awarded by NAVSEA/NSWC. The Government has certain rights in this invention.

### BACKGROUND

The present invention generally relates to mass spectroscopy. More specifically, the invention relates to an ion trap mass analyzer.

Ion trap mass spectrometry¹ is playing an increasingly important role in modern instrumental analysis. Capabilities for identifying and quantifying high and low molecular weight compounds, both in pure form and as components of complex mixtures, and with high sensitivity and specificity, facilitate the investigation of chemical or biochemical systems. The attractiveness of ion trap mass spectrometry is enhanced by the fact that high-quality analytical performance is achieved using a relatively simple device. In particular, the ability to perform multi-stage tandem mass spectrometry using a single analyzer in a single instrument represents a major advantage.

Electrodynamic ion traps date back to the pioneering work of Wolfgang Paul et al. in the 1950s.² These authors first described the three-dimensional electric quadrupole field established by three electrodes with hyperbolic surfaces and their ion trapping capabilities. When used as an ion trap, the ring electrode is supplied with a fixed megahertz radio frequency (RF) voltage and the two endcap electrodes are normally grounded. The mass-selective instability scan by Stafford³, which is achieved by scanning of the RF amplitude, allowed the Paul trap to be used in a straightforward way as a mass analyzer. Different ion trap geometries have evolved as modifications on the original Paul design, either for performance improvement or as adaptations for specific applications. The manipulation to the higher-order fields of the trap by stretching its geometry⁴ or changing the electrode shapes⁵ has been used to eliminate small mass shifts and so to improve mass resolution. While most commercial ion trap mass spectrometers employ the Paul geometry, difficulty in the accurate implementation of hyperbolic electrode structures in smaller traps more suited for portable mass spectrometers, as well as the relaxed analytical performance criteria for applications of portable analytical instruments, has led to intensive explorations of geometrically simpler alternatives. Accordingly, the cylindrical ion trap (CIT)⁶ has been developed into a mass analyzer by empirical optimization of its geometry,⁷ one in which a cylindrical electrode and planar endcaps replace the hyperbolic ring electrode and hyperbolic endcap electrodes of the conventional Paul trap. A mass/charge range up to 600 Th with unit resolution together with capabilities for recording product ion tandem mass spectra can be obtained using this significantly simplified geometry, which is easily fabricated and miniaturized to the sub-mm⁸ and even into the micron⁹ size range.

Both conventional Paul traps and CITs, however, have inherently limited ion trapping capacity, due to the 3D nature of the RF trapping field which confines trapped ions to a point at the center of the device.^{10, 11} Provided that space charge effects are held constant, analytical performance of ion traps increases with the number of trapped ions, which tend to be accumulated at or near this central point. The difficulties lead to increased interest in linear traps in which ions are trapped along a line, rather than at a point. So severe are the limitations of the Paul type traps that the actual number of ions trapped in a instrument of conventional size (few mm to 1 cm internal radius) is limited to only a few hundred under conditions of good resolution.¹² Further effort at optimizing higher-order fields inside 3D traps in order to maintain mass resolution while increasing the number of trapped ions has led to ingenious solutions¹⁰ although these have as yet met with only limited success.

In addition to the limitation in the total number of ions that can be trapped in a Paul 3D trap, these devices have a low trapping efficiency for externally injected ions due to the RF field alternating against the ions injected through the endcap electrode hole. Linear ion traps^{13, 14} improve both the trapping capacity and trapping efficiency for externally injected ions. To circumvent the mechanical difficulties analogous which hindered miniaturization of the Paul trap, a modified form of linear ion traps, the rectilinear ion trap (RIT), has been developed.¹⁵ This mass analyzer consists of two pairs (x and y) of planar electrodes mounted in parallel, as the counterparts of the hyperbolic rod set, and a pair of z electrodes, which are used as the endcaps. Like the CIT, the RIT is a mass analyzer of simplified geometry, but it is the simplified analog of the higher performance LIT, while the CIT is the geometrically simplified analog of the 3D Paul trap. Significantly better performance has been achieved using RITs compared to CITs of similar dimension operated under similar conditions. As expected, many of the advantages of the RIT are the result of its increased trapping capacity and improved injection efficiency.^{15-18,34}

The structure of linear ion traps is derived from the quadrupole mass filter with a pseudopotential well in the x-y plane (perpendicular to the ion optical axis) generated by an RF field. Instead of having a pseudopotential well in the third dimension as is the case in a 3D trap, linear ion traps have an additional DC potential well in the z direction formed by the DC voltages applied between the end sections and the RF electrodes.¹⁹ The end sections can be simply two planar lens elements^{14, 15} or two additional sections of RF electrodes.¹³ Unlike mass analysis using a 3D trap with fixed ratios of the dimensions in all three directions, mass analysis in a linear trap is not inherently dependent on the z dimension and a z-dimension much greater than the x and y dimensions is used to establish a cylindrical trapping volume that is considerably larger than the spherical volume generated by a 3D ion trap. This results in a significantly increased trapping capacity fundamentally associated with trapping along a line vs. at a point.^{1, 13, 14, 19} In addition, when dual-phase RF is used, the ions are injected into the linear trap along the axial direction and thus not subject to a direct RF retarding and accelerating field, and this leads to the increased trapping efficiency for external ion injection. These advantages are shared by both the higher quality field versions of linear ion traps and by the simplified RIT format.

The use of an RF-generated rather than a DC-generated trapping potential well is advantageous when linear ion traps are used for certain applications including ion/ion reactions,^{20, 21} electron caption dissociation²² and electron transfer dissociation,^{23, 24} where particles with opposite charges need to be trapped simultaneously. This requirement has been met for RF-only traps by superimposing a pseudopotential well along the z direction by applying AC signals on the end lenses^{20, 24} or using an unbalanced RF²¹ for the linear ion trap with z electrodes, although this requires additional electronic controls.

### SUMMARY

The effects of z-direction (that is, axial direction) DC potentials on ion trapping in conventional 6-electrode RITs were studied and the results suggested that the axial DC potential is unnecessary for ion trapping and subsequent mass analysis. Thus, in accordance with the invention, a 4-electrode structure, which is asymmetrical in the x-y plane (the “stretched” geometry), employs a pure RF potential for ion trapping in both the radial and axial directions and functions as a linear ion trap without performance loss compared to a conventional 6-electrode RIT. The geometric simplicity and the convenience of compensating for the trapping capacity loss due to the shrinking of the radial dimension by increasing its length, makes the 4-electrode RIT particularly significant for the development of the next generation of miniaturized mass spectrometers and for future instruments which will employ arrays of RITs arranged in two and three-dimensions.

In a general aspect of the invention, a rectilinear ion trap includes a first pair of spaced elongated planar electrodes, mounted in parallel, a second pair of spaced elongated planar electrodes, mounted in parallel and orthogonal to the first pair of electrodes, and an RF source which applies an RF potential to the pairs of electrodes for generating RF fields that trap ions in the radial and axial directions. In some implementations, the rectilinear ion trap is used for mass analysis. For example, the rectilinear ion trap can be used in combination with a mass-selective instability scan with ion ejection in the radial direction. The rectilinear ion trap may be combined with a detector, which includes, in some implementations, a dynode and an electron multiplier. The rectilinear ion trap can be used with an external ion source that injects ions into the trap in the axial direction. Alternatively, the trap can be used in combination with an internal electron ionizer, which includes, in some implementations, a filament. The rectilinear ion trap may be combined with a detector. The detector includes, in some implementations, a dynode and an electron multiplier.

Further features and advantages of this invention will be apparent form the following description, and from the claims.

### BRIEF DESCRIPTION OF THE DRAWINGS

FIG. 1a depicts a perspective view of a 6-electrode RIT.

FIG. 1b depicts a 4-electrode RIT in accordance with an embodiment of the invention with internal electron impact ionization.

FIG. 2 depicts mass spectra of PFTBA collected using stretched and un-stretched geometries of the RIT of FIG. 1a with z electrode voltages of 25 V, 0 V and −10 V

FIG. 3a depicts pseudopotential inside a stretched 6-electrode RIT of FIG. 1a with z electrodes 20.0 mm away from the end of RF electrodes, RF 200 V_{0-P}, 1.0 MHz.

FIG. 3b depicts pseudopotential well depth as a function of distance between the z and RF electrodes for stretched and un-stretched geometries of the 6-electrode RIT of FIG. 1a.

FIG. 3c depicts the simulation of trapping ions m/z 120, 105 and 77 inside the stretched geometry of the 6-electrode RIT of FIG. 1a with z electrodes 50.0 mm away from the ends of RF electrodes, 10 ms after the generation of the ions from a 0.2 mm diameter spherical volume, at 1.0×10⁻⁴ Torr He pressure, and considering elastic ion-He collisions and ion-ion columbic repulsion.

FIG. 4 depicts mass spectra of PFTBA collected using the 4-electrode RIT of FIG. 1b, with un-stretched (x₀=5.0 mm, y₀=5.0 mm) and stretched (x₀=5.0 mm, y₀=3.8 mm) geometries, z₀=40.0 mm.

FIG. 5 depicts the comparison of sensitivity and trapping capacity among the un-stretched and stretched geometries of the 6-electrode RIT of FIG. 1a and the 4-electrode RIT of FIG. 1b.

FIG. 6a depicts the stability diagram mapped for the stretched geometry of the 6-electrode RIT of FIG. 1a with 100 V DC applied on the z electrodes.

FIG. 6b depicts the stability diagram mapped for the stretched geometry of the 4-electrode RIT of FIG. 1b.

FIG. 7a depicts the MS³ spectrum of acetophenone collected using the stretched geometry of the 4-electrode RIT of FIG. 1a.

FIG. 7b depicts the molecular ion m/z 120 isolated using SWIFT notched at qₓ=0.64.

FIG. 7c depicts the product of the ion spectrum with excitation at 171 kHz and 440 mV₀₋ₚ. FIG. 7d depicts the sequential product ion spectrum of isolated m/z 105 with excitation at 224 kHz, 800 mV₀₋ₚ.

FIG. 8a depicts a 4-electrode RIT with an external ion source in accordance with an embodiment of the invention.

FIG. 8b depicts the mass spectrum of acetophenone collected using a stretched geometry of the 4-electrode RIT of FIG. 8a with ions injected axially into the RIT.

### DETAILED DESCRIPTION

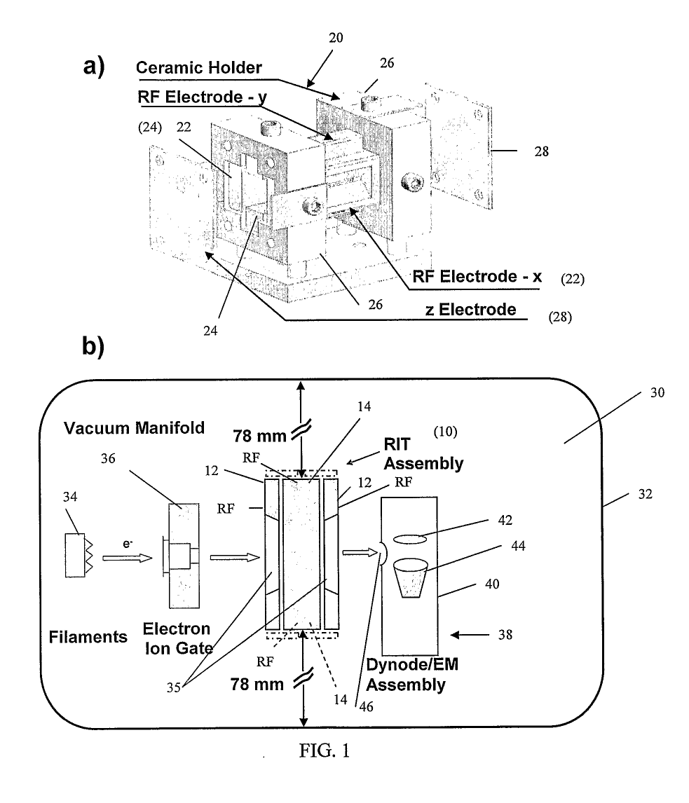

Referring now to FIG. 1b, a 4-electrode rectilinear ion trap (RIT) embodying the principles of the present invention is illustrated therein and designated at 10. As its primary components, the 4-electrode RIT 10 includes a pair of substantially parallel x-electrodes 12 and a pair substantially parallel y-electrodes 14 mounted orthogonally to planes of the x-electrodes 12. The 4-electrode RIT 10 employs an RF potential for ion trapping in the radial and axial directions. Mass analysis was achieved using the mass-selective instability scan with ion ejection in the radial direction. The 4-electrode RIT 10 provides optimum performance in an asymmetric geometry. Strong RF fringing fields at the ends of the RF rods account for axial ion trapping without use of extra electrodes or an axial DC voltage. As discussed below, field calculations and simulations were carried out to study the trapping potential inside the 4-electrode RIT 10 with various configurations. Demonstrated capabilities include analysis of externally injected ions with mass resolution in excess of 1000 and a mass/charge range of 650 Th as well as tandem mass spectrometry capabilities.

The 4-electrode RIT 10 employs a pure RF potential for ion trapping in both the radial and axial directions, that is, without the use of an axial DC potential. The geometric simplicity and the convenience of compensating for the trapping capacity loss due to the shrinking of the radial dimension by increasing its length, makes the 4-electrode RIT 10 particularly significant for the development of the next generation of miniaturized mass spectrometers and for future instruments which will employ arrays of RITs arranged in two and three-dimensions.

The performance of the 4-electrode RIT 10 was characterized in comparison with a 6-electrode RIT 20 shown in FIG. 1a. In addition to a pair of parallel x-electrodes 22 and a pair of parallel y-electrodes 24 mounted in a pair of ceramic holders 26, the 6-electrode RIT 20 includes a pair of z-electrodes 28 arranged orthogonally to the respective planes of the x-electrodes 22 and the y-electrodes 24.

A previously characterized 6-electrode RIT¹⁵ was used for purposes of comparison. This 6-electrode RIT was configured with x- and y-electrodes that were 40.0 mm in length. The half-distance between the x electrode pair (x₀) was 5.0 mm and the half-distance between the y pair (y₀) was adjustable. The closest gap between adjacent electrodes was fixed at 1.6 mm. Centrally located on each x-electrode was a slit 15.0 mm long and 1.0 mm wide. In certain implementations, the 4-electrode RIT 10 includes x- and y-electrodes of similar configurations but is stretched in the x direction by using a shorter half-distance (for example, 3.8 mm and 4 mm) between the y electrode pair (y₀). Thus, for the stretched configuration, x₀ was about 5 mm and y₀ was less than 5 mm, and for the un-stretched configuration both x₀ and y₀ were about 5 mm.

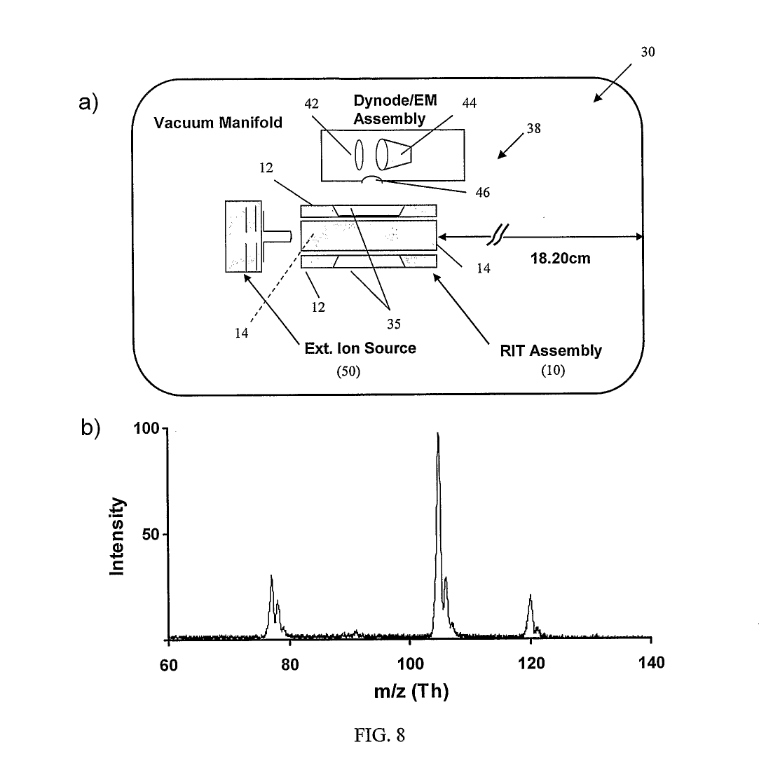

The 4-electrode RIT 10 was tested in the configuration shown in FIG. 1b using a modified prototype Thermo Finnigan ITMS.²⁵ An RF signal (1.1 MHz) was applied on the respective y-electrodes while the x-electrodes were virtually grounded so as to form an RF trapping field in the x-y plane. Internal electron impact (EI) ionization was used to ionize the vapors of molecules. Specifically, a heated filament 34 provided electrons to an electron ion gate 36 which injected ions into the trap radially through the slit 35 in one of the x-electrodes 12 in pulses of selected intervals and duration. In some implementations, ions were generated by 70 eV electron impact. The filament and ion injection controls were modified from the ITMS filament and electron gate control. Note that for experiments using external ion injection (see, for example, FIG. 8a), a GCQ EI/CI source 50 was employed.

The 4-electrode RIT 10 was installed into a vacuum manifold 30 some 78.0 mm distant from the manifold walls 32. A DeTech 397 detector assembly 38 (Detector Technology, Inc., Palmer, Mass., US) was used in the experiment. It has a stainless steel case 40 that shields the conversion dynode 42 and the electron multiplier 44 and helps to minimize interference from the applied high voltages. An opening 46 of about 12.5 mm diameter on the detector casing 40 allows ions to enter the detector 38. Electric connections and wires were carefully placed to minimize possible fringing fields along the z axis of the RIT. A similar test configuration was used the 6-electrode RIT 20.

Trapped ions were mass-selectively ejected by scanning the RF amplitude at a rate of 16,665 Th/s. A supplementary low voltage AC signal, generated using a WaveTek 395 arbitrary waveform generator (WaveTek, San Diego, Calif., USA) and amplified by a Balun amplifier, was applied between the x-electrodes to provide a dipolar field for resonance ejection to facilitate ion ejection during the RF scan. This field was also used for ion excitation in the collision-induced dissociation (CID) experiments. Either RF/DC or SWIFT (stored waveform inverse Fourier transform)²⁶ waveform isolation was used for ion isolation in MSⁿ experiments, as indicated. The SWIFT waveforms were calculated using the Ion Trap Simulation program²⁷ (ITSIM) Ver. 5.0 research version, generated using WaveForm DSP2 software (Version 2.02), and then deployed with the Wavetek 395-64k 100 MHz Synthesized Arbitrary Waveform Generator. Ions ejected from the RITs 10, 20 were detected using the DeTech detector assembly 40 noted above which was equipped with an electron multiplier 44, operated at −1,200 V and with a conversion dynode 42 operated at −5,000 V. The signal was first amplified using the preamplifier in the ITMS and then acquired using a digital oscilloscope (Model TDS 540; Tektronix Beaverton, Oreg., USA) at a sampling rate of 250 K samples/s.

Helium was used as buffer gas at an indicated pressure of ca. 8.5×10⁻⁵ Torr, measured using a Bayert-Alpert type ionization gauge. Headspace vapor of the organic compounds of interest, after purification by a freeze-pump-thaw cycle, was leaked into the vacuum through a Granville-Phillips (Granville-Phillips Co., Boulder, Colo., USA) leak valve to maintain an indicated pressure of 8.0×10⁻⁷ Torr.

The ITSIM programs, versions 5.0 or earlier, can be used for simulations of trapping devices with cylindrical geometries, like 3D ion traps. To simulate ion motion inside an RIT, a newer version of the program Ver. 6.0, was developed. The name “Ion Trajectory SIMulation (ITSIM)” is used for this and future versions with the program to emphasize the extended capabilities of simulating ion trajectories in electric devices of arbitrary geometries. The mechanical models of the RITs 10, 20, generated by Mechanical Desktop 4.0 (AutoDesk, 2004), were input into a finite element 3D field solver FEMLAB 3.0a (COMSOL, Inc., Burlington, Mass., US) and the electric field was analyzed with a maximum mesh element size of 0.8 mm. The solved electric field was exported and converted into a field array file which was used by ITSIM 6.0 for simulation of ion trajectories under various experimental conditions.

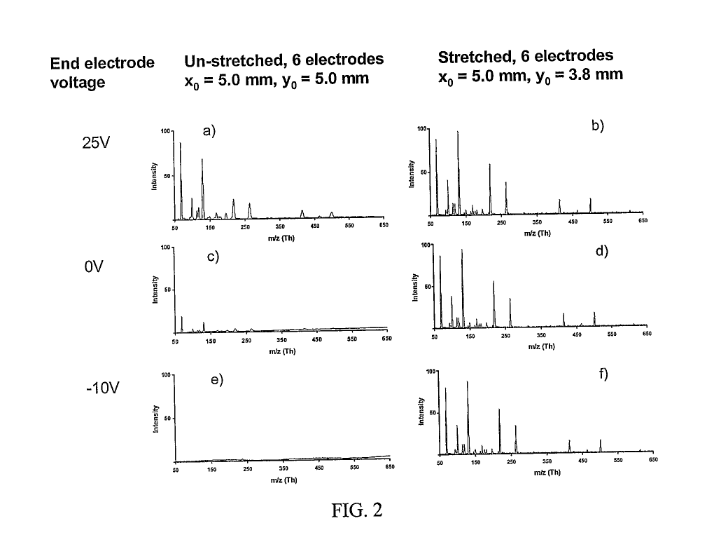

The analytical performance of the 6-electrode RIT 20 was optimized by using traps of stretched geometry with the inner RF electrode distance shorter in the y- than in the x-direction.¹⁵ The use of a higher DC voltage on the z-electrodes 28 was also found to help improve the resolution by pushing ions towards the center of the RIT 20 in the axial (z) direction.¹⁵ Variation of the z-electrode 28 voltage was found to have significant effects on the trapping efficiency and ion trapping capacity of the 6-electrode RIT 20, both with or without stretched geometries. As shown in FIGS. 2a, 2c, 2e and FIGS. 2b, 2d, 2f, mass spectra of perfluorotributylamine (PFTBA) were collected using un-stretched and stretched geometries, respectively, of the 6-electrode RIT 20 with z-electrode voltages at 25, 0 and −10 V, while all other experimental conditions, including the leaked PFTBA vapor pressure, buffer bas pressure, ionization time and the low mass cutoff (LMCO, at m/z 50), were kept identical for each experiment. The spectra were collected using 2 ms ionization at a constant LMCO, 10 ms cooling time and using a constant RF scan rate of 16,665 Th/s. The frequency and amplitude of the resonance ejection AC signal was adjusted to maximize the ion signal intensity for each geometry. When the z-electrode voltage was set to 0 V, the z-direction DC trapping potential well depth is 0 V; however, the ions can still be trapped in the RIT, as shown in FIGS. 2c and 2d. This phenomenon is due to the pseudopotential well resulting from the unbalanced RF when a dual-phase RF with unequal amplitudes for each phase is applied between x- and y-electrodes. This method has been applied to allow simultaneous trapping of positive and negative ions in the linear ion trap.²¹ With a single phase RF applied only to the y electrodes 24, the pseudopotential well depth was maximized for each experiment. However, a 6-electrode RIT with the stretched geometry has a higher trapping efficiency when using an identical LMCO (FIG. 2d). Decreases of 70% (FIG. 2c) and 100% (FIG. 2e) in intensity were observed for the un-stretched 6-electrode RIT 20 when the z-electrode voltage was dropped from 25 V to 0 V and to −10 V, respectively, while little decrease was detected in the total ion current for the stretched 6-electrode RIT 20 in both cases (FIGS. 2d and 2f). A significant signal decrease was observed for the stretched 6-electrode RIT 20 when the z-electrode voltage was decreased below −20 V. The observed difference in the trapping efficiency suggests that the 6-electrode RIT 20 with stretched geometry has a greater pseudopotential well depth, which helps compensate for z-axis ejection due to the DC potential.

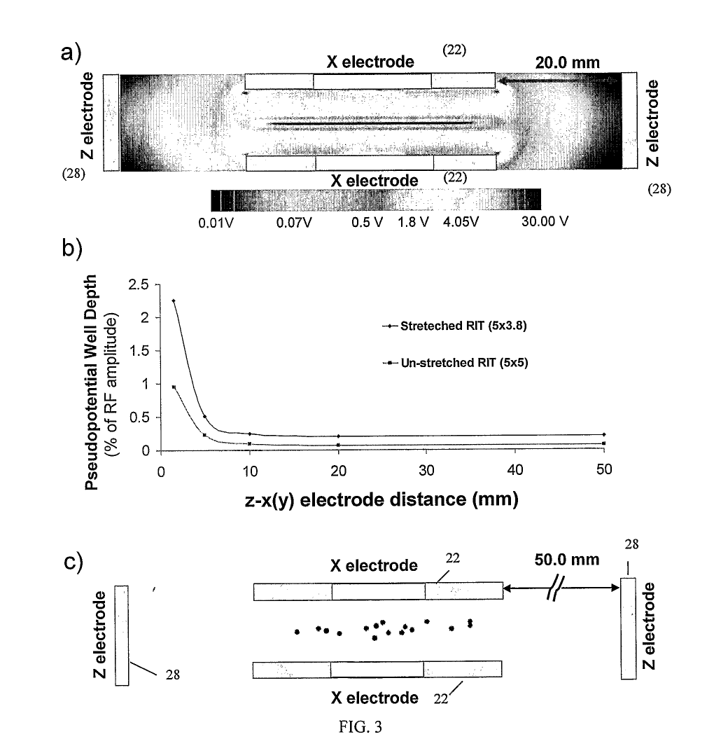

To better understand the ion trapping behavior for both 6-electrode RIT geometries, field calculations and ion trapping simulations were carried out to illustrate the variation of the pseudopotential along the z-axis under various conditions. For both the un-stretched and stretched geometry, the distance between the grounded z electrode and the ends of the RF electrodes 22,24 was varied from 2.0 mm to 50.0 mm. The electric field for each RIT configuration was solved using FEMLAB 3.0a with unit voltage applied to the y-electrodes 24, leaving the x- and z-electrodes 22, 28 grounded. The pseudopotential at the central point of x-y plane on two ends of RF electrodes was subsequently calculated for the ions under the condition qₓ<0.4 using ITSIM 6.0 with the solved field and the following equation:²⁸

$${Φ}_{0} ( x , y , z ) = \frac{1}{4 ( m / e ) {Ω}^{2}} {E}_{0}^{2} ( x , y , z )$$

where Φ₀ (x,y,z) is the static pseudo potential, m/e is the mass-to-charge ratio of ion, Ω is the angular frequency of the applied RF and E₀ (x,y,z) is the amplitude of the electric field inside the device scaled up from that calculated using FEMLAB 3.0a. The pseudopotential was calculated for the ion m/z 105 with an RF of 200 V_{0-P} and 1.0 MHz. The pseudopotential for the 6-electrode RIT 20 in the x-z plane can be plotted as shown in FIG. 3a and the pseudopotential wells along the z-axis were found for the all the RITs tested; the well depths varied significantly among the different configurations. The z-axis pseudopotential well is attributed to the RF fringing field caused by truncation, that is, by the finite length of the RF electrodes 22, 24, and it is usually smaller than that in the x- and y-directions. The pseudopotential well depths along the z-axis were quantified as a percentage of the RF amplitude and plotted as a function of the distance between the z-electrodes 28 and the end of the RF electrodes 22, 24 with un-stretched and stretched geometries, respectively (FIG. 3b). The well depth for each stretched 6-electrode RIT 20 was found to be about twice that for the corresponding un-stretched 6-electrode RIT 20 when the same RF was applied. As observed from the calculated results, pseudopotential well depth decreases significantly with increasing spacing between the z electrode 28 and RF electrodes 22, 24 but approaches a constant value when the distance is larger than 15.0 mm. The trapping of the ions in a stretched 6-electrode RIT 20 with z-electrode gap of 50.0 mm was also simulated using ITSIM 6.0. The ions from acetophenone m/z 77, 105 and 120, with abundances of 87, 100 and 30 for each m/z value, were generated inside a spherical volume with a diameter of 0.2 mm at the center of the RIT apparatus. An initial thermal energy of kT/3 (0.008 eV at room temperature) along the x-, y- and z-directions was given to each ion. An RF of 200 V_{0-P} and 1.0 MHz was applied on the y-electrodes 24. A helium buffer gas pressure of 1.0×10⁻⁴ Torr, elastic ion-neutral collisions and columbic repulsions among the ions (space charge condition) were used in the simulation. As shown in FIG. 3c, the ions were spread out in the 6-electrode RIT 20 after 10 ms due to the space charge effect and the collisions with the buffer gas molecules; however, 100% trapping efficiency was achieved and no ions escaped in the z-direction (note that a maximum of only 16 ions can be shown as in FIG. 3c because of limitations in the graphical display during the simulation although all 217 ions were trapped in the simulation).

The z-electrodes of 6-electrode RIT 20 help to prevent penetration of external fields, serve as electric ground references and contribute to the electric field distribution in the areas around the end of the RIT where the distance between the z-electrode 28 and the RF electrodes 22, 24 is small in comparison with x₀ and y₀. However, in the cases where the z-electrodes 28 are far from the RF electrodes 22, 24, such as about 50.0 mm or further for a 6-electrode RIT 20 with an x₀ of 5.0 mm, the shape of the z-electrode likely has little effect on the RIT performance. Note that inside the vacuum manifold of an ion trap mass spectrometer, there almost always are electrically conducting objects within a distance of 50.0 mm from the mass analyzer, which can serve as electric ground references for the RF. Thus, in accordance with the invention, an RIT without z-electrodes still has a pseudopotential well in the z-direction when a single phase RF, which is an extreme case of the unbalanced RF, is used.

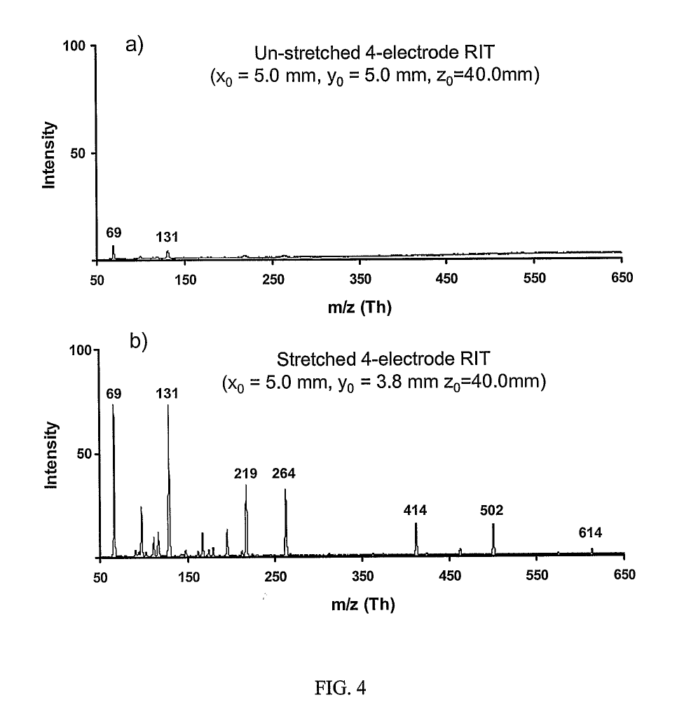

The 4-electrode RIT 10 was installed into the vacuum manifold for tests, using a distance of 78.0 mm between each end of the RIT and the each side wall of the manifold (FIG. 1b). Mass spectra of PFTBA were recorded for un-stretched and stretched geometries under the identical experimental conditions described above for the 6-electrode RIT, as shown in FIGS. 4a and 4b. With the same ionization time of 2 ms and optimized resonance ejection conditions, the ion intensity from the spectrum recorded with the stretched 4-electrode RIT is much higher, which indicates a higher trapping efficiency for this trap. This is also in agreement with the simulation result in which a deeper pseudopotential well was observed for a 4-electrode RIT with stretched geometries.

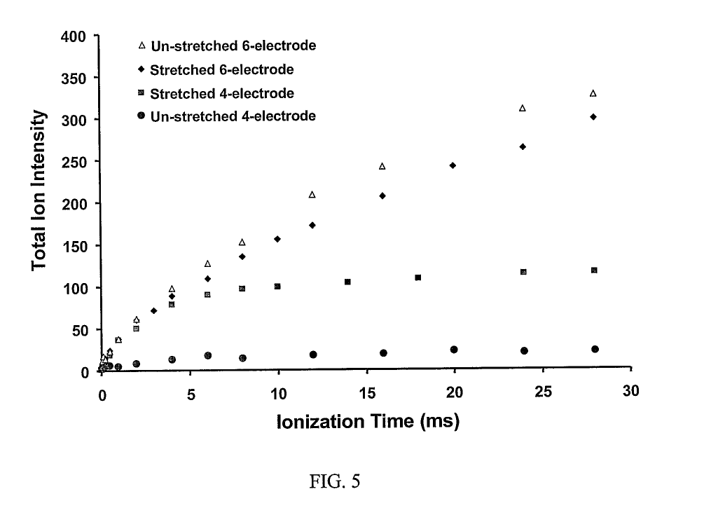

A comparison of the overall trapping efficiency and ion trapping capacity was made amongst four RIT structures, namely, un-stretched 4-electrode, stretched 4-electrode, un-stretched 6-electrode and stretched 6-electrode versions. In the tests using the 6-electrode RIT 20, a voltage of 25 V was applied to the z-electrodes 28. The experimental conditions were kept the same except that the ionization time was varied. Spectra of acetophenone were recorded as a function of the ionization time for each RIT 10, 20. With a LMCO RF voltage of 120 V, ions of m/z 77, 105 and 120 were observed in each spectrum, for which the total ion intensity was calculated and plotted vs. the corresponding ionization time (FIG. 5). The stretched 4-electrode RIT 10 was shown to have a trapping efficiency similar to the stretched and un-stretched 6-electrode RITs 20, at ionization times shorter than 8 ms. For the un-stretched 4-electrode RIT 10, the z-axis pseudopotential is relatively shallow and the ions that gain kinetic energy from the driving RF or through the collision with the buffer gas can easily escape at the two ends of the RIT. At ionization time longer than 8 ms, the stretched 4-electrode RIT reaches it's maximum ion trapping capacity while the 6-electrode RITs are still responding to the increased ionization time. Much larger capacities are indicated for the RITs with an additional 25 V DC trapping potential well along the z-direction, which helps to prevent the escape of the ions caused by space charge effects.²⁸

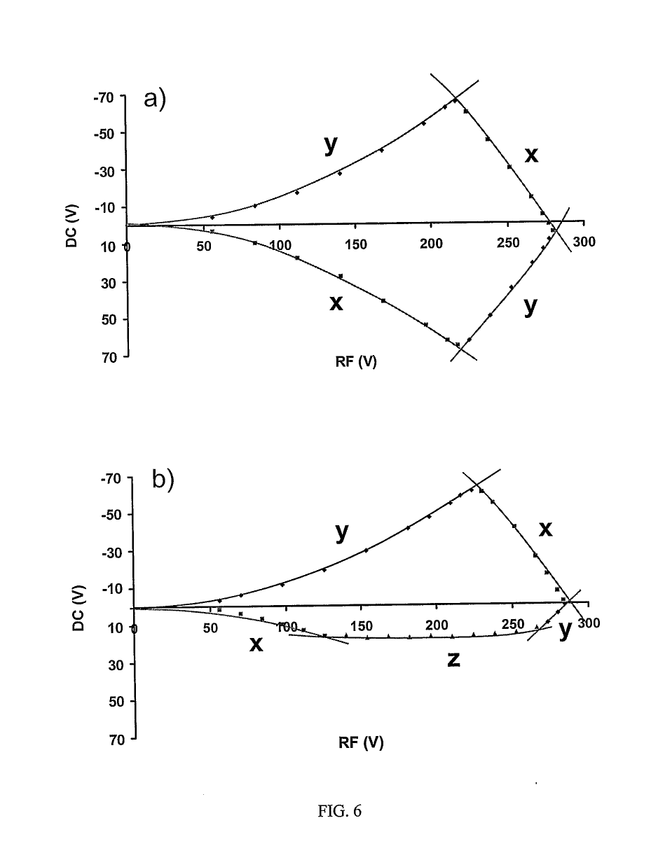

The stability diagram has been used to characterize ion traps and to facilitate the design of control programs for tandem mass spectrometry.²⁹ The stability diagrams were mapped using the method previously reported^{6, 15} and the fragment ion m/z 105 from acetophenone was used. The boundary of the stability program was found by varying the RF voltage and the DC offset applied on the RIT y electrodes 14, 24, as shown in FIG. 6b and FIG. 6a, respectively. The stretched 6-electrode RIT 20 was shown to have a stability diagram (FIG. 6a) similar to that of an un-stretched RIT¹⁵ except for a slight shift of the intercept of the x- and y-boundary on the right side, which is similar to effects observed for 3D traps and is caused by the unequal dimensions in the x- and y-directions. The top half of the stability diagram (FIG. 6b) for the 4-electrode RIT is similar to that of the 6-electrode RIT, while the bottom half is flattened, for the ion m/z 105, at a DC offset voltage of 16 V. When the RF offset DC voltage is increased, the center voltage of the RIT is also increased and an ejecting DC potential along the z axis is formed for positive ions. When the DC voltage is high enough to overcome the pseudopotential well generated in the z direction by the RF, positive ions will become unstable in the z direction. As a result, the stability boundary in z-direction can be mapped as a function of the amplitudes of the RF and its offset DC, which is not the case for 6-electrode RITs.

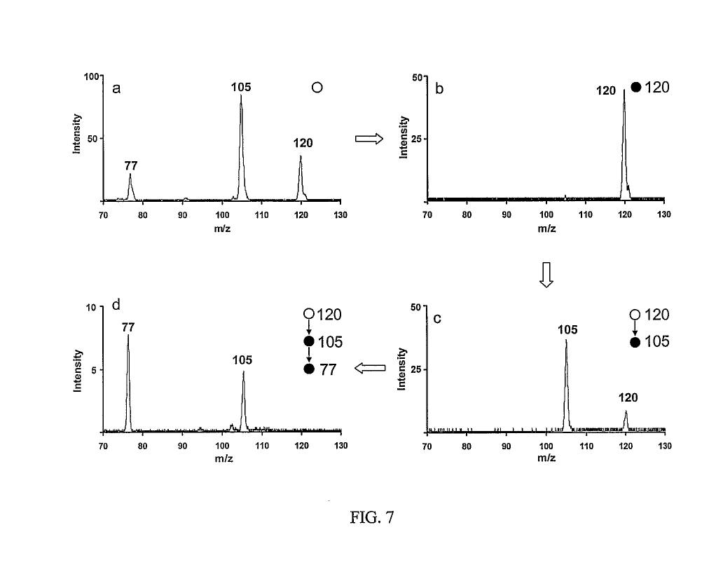

The capability of performing the tandem mass spectrometry in a single device is a unique feature of the ion trap mass analyzer. The MSⁿ capability of the 6-electrode RIT has been demonstrated¹⁵ and fully characterized.¹⁶ As discussed above, the 4-electrode RIT 10 is shown to have comparable MS capabilities using internal EI. The isolation of the ions inside a 4-electrode RIT via RF/DC isolation proved to be applicable during the process of mapping the stability diagram. Experiments were also carried out using notched SWIFT for precursor ion isolation and AC excitation of the selected ions to cause CID. Two stage MS/MS experiments were performed using a stretched 4-electrode RIT 10 with the molecular ion m/z 120 of acetophenone as the starting precursor ion. A notched SWIFT was used to isolate the precursor ions at qₓ=0.64 and a 100% isolation efficiency was achieved with a isolation window of 5 m/z. A resonant AC of 171 kHz frequency and 440 mV₀₋ₚ amplitude was used to excite m/z 120 at qₓ=0.28 for 30 ms and fragment ions m/z 105 were observed with a ca. 70% CID efficiency (FIGS. 7a, b, and c). The fragment ion m/z 105 was further isolated using the same notched SWIFT and was excited at qₓ=0.28 with using a second AC signal of 224 kHz and 800 mV₀₋ₚ. Fragmentation of m/z 105 occurred and product ions of m/z 77 were observed (FIGS. 7d and e). These CID conditions were similar to those used for the characterization of the CID capability of the 6-electrode RIT¹⁵ and similar isolation and fragmentation efficiencies were observed for the 4-electrode RIT. During the isolation and excitation of the ions, the collisions between the ions and buffer gas molecules can increase the ion momentum in the z-direction and cause the escape of the ions from the ends of RIT; however, the RF pseudopotential well is deep enough to constrain the ions inside the 4-electrode RIT 10.

The RF pseudopotential well along the axis of the 4-electrode RIT 10 is effective in trapping ions generated inside the RIT via El and retaining them for MS and MSⁿ analysis. Moreover, the performance of the stretched 4-electrode RIT 10 was also tested in external ion injection and comparisons were made with the stretched 6-electrode RIT 20. The instrumentation for this test is shown in FIG. 8a with a modified Finnigan GCQ EI/CI source 50 being used to provide ions. The acetophenone molecules were ionized by 70 eV El and the ions were delivered to the RIT using a three-lens system. The exit of the third lens is 2.0 mm away from the end of the RIT 10 and a voltage of −18.4 V was applied to it. As such, in some implementations, the third lens of the external ions source acts as a z-electrode. The 4-electrode RIT 10 was floated at −18 V. A spectrum of acetophenone was acquired with an ionization time of 100 ms at an electron emission current of 1.5 μA from the filament (FIG. 8b). Spectra with similar signal-to-noise ratios were collected for the stretched 6-electrode RIT 20 at a shorter ionization time of 20 ms with the help of DC potential well of just 0.2 V in z direction, which indicates a 5 times improvement in comparison with the 4-electrode RIT. The trapping efficiency for the externally injected ions in the traps using pseudopotential wells is estimated to be much lower than those using DC potential wells, typical values being 5% for 3D trap³⁰ vs. up to 100% for linear ion trap.³¹ A difference of a factor of five in the overall efficiency was observed between the 4-electrode and 6-electrode RIT in this experiment. The efficiency for the 4-electrode RIT 10 can be improved by introducing the ions into the RIT as an open configuration without an additional electrode between the ion source and the RIT.

The 4-electrode RIT 10 represents an additional simplification to the rectilinear ion trap geometry. It functions as a mass analyzer with adequate performance, that is, simultaneous trapping of ions in a mass range up to 650 Th with unit mass resolution, tandem mass spectrometry capabilities and the ability to analyze externally injected ions. Three dimensional ion trapping was achieved through a combination of radial trapping by the main RF and axial trapping by the RF fringe field axial components which establish a pseudopotential barrier at each end of the four electrodes.

The use of the pseudopotential well in the 4-electrode RIT 10 makes it a good candidate linear trap for the instruments where ions with both positive and negative charges are simultaneously trapped. The simple structure of the 4-electrode RIT 10 makes it particularly significant in the development of miniaturized instruments. The trapping capacity loss accompanying decreases in the x- and y-dimensions, to allow the use of lower RF voltages, can be compensated at least in part by increased trap length. The large opening in the z-direction allows a much higher injecting ion or electron current. It represents a vital step toward fabrication of massive arrays of miniaturized ion trap mass analyzer,^{9, 32, 33} since this highly simplified device can be produced with considerable greater ease using metal coated glass tubes which will largely reduce manufacturing costs and bring closer the time of the “throw away” mass analyzer.

In other embodiments, AC or a waveform can be applied between at least one pair of the electrodes to manipulate, isolate, and/or excite ions. In some embodiments, RF float DC voltages may be applied to the electrodes to isolate the electrodes. Positively and negatively charged ions may be mutually stored in the trap, and simultaneous mass analysis may be performed on the positively and negatively charged ions. Multiple traps may be employed multiplex configurations. For example, the traps may be arranged in series such that ions are transferred between the traps in the z direction, or the traps may be arranged in parallel such that ions are transferred between the traps in the x or y direction. In some configurations, multiple traps are arranged both in series and parallel such that the ions are transferred in the x, y, and z directions. Such configurations are described in U.S. Pat. No. 6,838,666, the entire contents or which are incorporated herein by reference.

### REFERENCES

(1) March, R. E.; Todd, J. F. J. Quadrupole Ion Trap Mass Spectrometry, 2nd ed.; John Wiley and Sons, 2005.

(2) Paul, W.; Steinwedel, H. A New Mass Spectrometer without a Magnetic Field, Z. Naturforsch. 1953, 8a, 448.

(3) Stafford, G. C.; Kelley, P. E.; Syka, J. E. P.; Reynolds, W. E.; Todd, J. F. J. Recent Improvements in and Analytical Applications of Advanced Ion Trap Technology, Int. J. Mass Spectrom. Ion Processes 1984, 60, 85-98.

(4) Syka, J. E. P. In Practical Aspects of Ion Trap Mass Spectrometry; March, R. E., Todd, J. F. J., Eds.; CRC Press: Boca Raton, Fla., 1995; Vol. 1, pp 169.

(5) Franzen, J. The Non-linear Ion Trap. Part 4. Mass Selective Instability Scan with Multipole Superposition, Int. J. Mass Spectrom. Ion Processes 1993, 125,165-170.

(6) Wells, J. M.; Badman, E. R.; Cooks, R. G. A Quadrupole Ion Trap with Cylindrical Geometry Operated in the Mass-Selective Instability Mode, Anal. Chem. 1998, 70, 438-444.

(7) Wu, G.; Cooks, R. G.; Ouyang, Z. Geometry Optimization for the Cylindrical Ion Trap: Field Calculations, Simulations and Experiments, Int. J. Mass Spectrom. 2005, 241, 119-132.

(8) Kornienko, O.; Reilly, P. T. A.; Whitten, W. B.; Ramsey, J. M. Micro Ion Trap Mass Spectrometry, Rapid Commun. Mass Spectrom. 1999, 13, 50-53.

(9) Blain, M. G.; Riter, L. S.; Cruz, D.; Austin, D. E.; Wu, G.; Plass, W. R.; Cooks, R. G. Towards the Hand-Held Mass Spectrometer: Design Considerations, Simulation, and Fabrication of Micrometer-Scaled Cylindrical Ion Traps, Int. J. Mass Spectrom. 2004, 236, 91-104.

(10) March, R. E.; Todd, J. F. J., Eds. Practical Aspects of Ion Trap Mass Spectrometry, Vol. I: Fundamentals of Ion Trap Mass Spectrometry; CRC Press: Boca Raton, Fla., 1995.

(11) Kocher, F.; Favre, A.; Gonnet, F.; Tabet, J.-C. Study of Ghost Peaks Resulting from Space Charge and Non-Linear Fields in an Ion Trap Mass Spectrometer, J. Mass Spectrom. 1998, 33, 921-935.

(12) Schwartz, J. C., 9th Sanibel Conference on Mass Spectrometry, Sanibel Island, Fla. 1997.

(13) Schwartz, J. C.; Senko, M. W.; Syka, J. E. P. A Two-Dimensional Quadrupole Ion Trap Mass Spectrometer, J. Am. Soc. Mass Spectrom. 2002, 13, 659-669.

(14) Hager, J. M. A New Linear Ion Trap Mass Spectrometer, Rapid Commun. Mass Spectrom. 2002, 16, 512-526.

(15) Ouyang, Z.; Wu, G.; Song, Y.; Li, H.; Plass, W. R.; Cooks, R. G. Rectilinear Ion Trap: Concepts, Calculations, and Analytical Performance of a New Mass Analyzer, Anal. Chem. 2004, 76, 4595-4605.

(16) Song, Q.; Kothari, S.; Senko, M. A.; Schwartz, J. C.; Amy, R. J. W.; Stafford, G. C.; Cooks, R. G.; Ouyang, Z. Rectilinear Ion Trap Mass Spectrometers with Atmospheric Pressure Interface and Electrospray Ionization Source, Anal. Chem. 2006, 78, 718-725.

(17) Zhang, C.; Chen, H.; Guymon, A. J.; Wu, G.; Cooks, R. G.; Ouyang Z. Instrumentation and Methods for Ion and Reaction Monitoring Using A Non-Scanning Rectilinear Ion Trap, Int. J. Mass Spectrom. 2006, In press.

(18) Tabert, A. M.; Goodwin, M. P.; Cooks, R. G. Co-occurrence of Boundary and Resonance Ejection in a Multiplexed Rectilinear Ion Trap Mass Spectrometer, J. Am. Soc. Mass Spectrom. 2006,17, 56-59.

(19) Douglas, D. J.; Frank, A. J.; Mao, D. Linear Ion Traps in Mass Spectrometry, Mass Spectrom. Rev. 2005, 24, 1-29.

(20) Xia, Y.; Liang, X.; McLuckey, S. A. Sonic Spray as a Dual Polarity Ion Source for Ion/Ion Reactions, Anal. Chem. 2005, 77, 3683-3689.

(21) Xia, Y.; Wu, J.; McLuckey, S. A.; Londry, F. A.; Hager, J. W. Mutual Storage Mode Ion/Ion Reactions in a Hybrid Linear Ion Trap, J. Am. Soc. Mass Spectrom. 2005, 16,71-81.

(22) Zubarev, R. A.; Kelleher, N. L.; McLafferty, F. W. Electron Capture Dissociation of Multiply Charged Protein Cation. A Nonergodic Process, J. Am. Chem. Soc. 1998, 120, 3265-3266.

(23) Pitteri, S. J.; Chrisman, S. A.; McLuckey, S. A. Electron Transfer Ion/Ion Reactions of Doubly Protonated Peptides: The Effect of Elevated Bath Gas Temperature, Anal. Chem. 2005, 77, 5662-5669.

(24) Syka, J. E. P.; Coon, J. J.; Schroeder, M. J.; Shabanowitz, J.; Hunt, D. F. Peptide and Protein Sequence Analysis by Electron Transfer Dissociation Mass Spectrometry, Proc. Natl. Acad. Sci. USA 2004, 101, 9528-9533.

(25) Louris, J. N.; Cooks, R. G.; Syka, J. E. P.; Kelley, P. E.; Stafford, G. C.; Todd, J. F. J. Instrumentation, Applications, and Energy Deposition in Quadrupole Ion-Trap Tandem Mass Spectrometry, Anal. Chem. 1987, 59,1677-1685.

(26) Guan, S. H.; Marshall, A. G. Stored Wave-Form Inverse Fourier-Transform Axial Excitation/Ejection for Quadrupole Ion Trap Mass Spectrometry, Anal. Chem. 1993, 65,1288-1294.

(27) Bui, H. A.; Cooks, R. G. Windows Version of the Ion Trap Simulation Program ITSIM: A Powerful Heuristic and Predictive Tool In Ion Trap Mass Spectrometry, J. Mass Spectrom. 1998, 33, 297-304.

(28) Dehmelt, H. G. Radiofrequency Spectroscopy of Stored Ions I: Storage, Adv. Atom. Mol. Phys. 1967, 3, 53-72.

(29) Todd, J. F. J.; Waldren, R. M.; Mather, R. E.; Lawson, G. On the Relative Efficiencies of Confinement of Ar⁺ and Ar²⁺ Ions in a Quadrupole Ion Storage Trap (QUISTOR), Int. J. Mass Spectrom. Ion Physics 1978, 28, 141-151.

(30) Quarmby, S. T.; Yost, R. A. Fundamental Studies of Ion Injection and Trapping of Electrosprayed Ions on a Quadrupole Ion Trap, Int. J. Mass Spectrom. 1999, 190/191, 81-102.

(31) Dolnikowski, G. G.; Kristo, M. J.; Enke, C. G.; Watson, J. T. Ion-Trapping Technique for Ion/Molecule Reaction Studies in the Center Quadrupole of a Triple Quadrupole Mass Spectrometer, Int. J. Mass Spectrom. Ion Processes 1988, 82, 1-15.

(32) Misharin, A. S.; Laughlin, B. C.; Vilkov, A.; Takats, Z.; Ouyang, Z.; Cooks, R. G. High-Throughput Mass Spectrometer Using Atomospheric Pressure Ionization and a Cylindrical Ion Trap Array, Anal. Chem. 2005, 77, 459-470.

(33) Tabert, A. M.; Griep-Raming, J.; Guymon, A. J.; Cooks, R. G. High-Throughput Miniature Cylindrical Ion Trap Array Mass Spectrometer, Anal. Chem. 2003, 75, 5656-5664.

(34) U.S. Pat. No. 6,838,666.

Other embodiments are within the scope of the following claims.

What is claimed is:

1. A rectilinear ion trap comprising:
a first pair of spaced planar RF electrodes, the first pair of electrodes being substantially parallel;
a second pair of spaced planar RF electrodes, the second pair of electrodes being substantially parallel and arranged substantially orthogonal to the first pair of electrodes, the configuration of the first pair of electrodes and the second pair of electrodes defining an axial direction and a radial direction; and
an RF source for applying an RF voltage to at least one of the pairs of electrodes to generate RF fields to trap ions in the axial and radial directions.

2. The trap of claim 1 wherein the spacing between the second pair of electrodes is less than the spacing between the first pair of electrodes.

3. The trap of claim 1 wherein the first pair of electrodes is grounded and the RF voltage is applied to the second pair of electrodes.

4. The trap of claim 1 wherein each of the first pair of electrodes is provided with a slit, ions being injected into the trap through one of the slits and being ejected from the trap from the other slit.

5. The trap of claim I wherein three dimensional ion trapping is achieved through a combination of radial trapping by a main RF field and axial trapping by RF fringe field axial components which establish a pseudopotential barrier at each end of the four electrodes.

6. A mass analyzer including the trap of claim 1 wherein ions are provided by internal electron impact ionization.

7. The mass analyzer of claim 6 further comprising a filament that generates electrons and an electron ion gate that receives the electrons and injects ions into the trap.

8. The mass analyzer of claim 6 wherein ions are mass-selectively ejected from the trap.

9. The mass analyzer of claim 8 wherein ions are mass-selectively ejected by scanning the amplitude of the RF voltage.

10. The mass analyzer of claim 8 further comprising a detector for identifying the ejected ions.

11. The mass analyzer of claim 10 wherein the detector includes a dynode.

12. The mass analyzer of claim 10 wherein the detector includes an electron multiplier.

13. The mass analyzer of claim 6 wherein ions are provided by an external ion source.

14. The mass analyzer of claim 13 wherein the ions are injected into the trap in the axial direction.

15. The mass analyzer of claim 6 wherein the trap is housed in a manifold which generates a vacuum.

16. The trap of claim 1 wherein each of the first pair of electrodes and each of the second pair of electrodes is provided with a slit, ions being injected into the trap through at least one of the slits and being ejected from the trap from at least one of the other three slits.

17. The trap of claim 1 wherein AC or a waveform is applied between at least one pair of the electrodes to manipulate, isolate, or excite ions or a combination thereof.

18. The trap of claim 1 wherein RF float DC voltages are applied to the electrodes to isolate the electrodes.

19. The trap of claim 1 wherein positively and negatively charged ions are mutually stored in the trap, simultaneous mass analysis being performed on the positively and negatively charged ions.

20. A multiplex system of ions traps including a plurality of rectilinear ion traps of claim 1.

21. The system of claim 20 wherein the plurality of raps are arranged in series, the ions being transferred between the traps in the z direction.

22. The system of claim 20 wherein the plurality of traps are arranged in parallel, the ions being transferred between the traps in the x or y direction or in both directions.

23. The system of claim 20 wherein the plurality of traps are arranged both in series and parallel, the ions being transferred between the traps in the x, y, and z directions.
